(19) United States
(12) Patent Application Publication
(10) Pub. No.: US 2010/0144375 A1
(43) Pub. Date: Jun. 10, 2010

(54) Method for Determining the Path of a Person Equipped With a Mobile Phone Device

(75) Inventors: Jorg Pfister, Bad Camberg (DE); Bernd Fritz Geppert, Seeheim-Jugenheim (DE); Uwe Plank-Wiedenbeck, Offenbach (DE); Christoph Zimmer, Vallendar (DE)

Correspondence Address: PRIEST & GOLDSTEIN PLLC, 5015 SOUTHPARK DRIVE, SUITE 230, DURHAM, NC, 27713-7736, US

(73) Assignee: ZEUS SYSTEMS GMBH, BRIG (CH)

(21) Appl. No.: 12/531,167

(22) PCT Filed: Mar. 19, 2008
(86) PCT No.: PCT/EP08/02205

§ 371 Date: Feb. 2, 2010

(30) Foreign Application Priority Data
Mar. 27, 2007 (DE) 10 2007 014 528.6

(51) Int. Cl. H04W 4/02; H04W 4/12

(52) U.S. Cl. 455/456.5; 455/466

(57) ABSTRACT

The invention relates to a method, which can be used to determine the local itinerary of a user of a variety of public means of transportation. Based on said determined itinerary then the travel cost can be equitably distributed among the individual operators of the means of transportation. The basis of the method is a comparison of the coordinates of stops of the public means of transportation with the coordinates of base stations for sending and receiving operations in mobile phone communication (GSM). Said coordinates must be determined only once and can be stored in a memory. If the coordinates of a base station into which a mobile phone is logged are close to the coordinates of a stop, it is assumed that the user of the mobile phone is located at said stop. During the travel of the user of the public means of transportation, it is detected at regular intervals—for example in intervals of 30 seconds—into what base station the mobile phone is logged. Then it is determined again which stop is the shortest distance from the base station just activated, and a conclusion is drawn about a line that the user is traveling on. Since the base method is still prone to inaccuracies, additional measures may be taken in order to make the route of the user of the mobile phone more precise. Such a measure is, for example, the comparison of the official schedule with the measured time and location information. By utilizing certain steps of the method it can also be checked whether the owner of the mobile phone is in possession of a properly purchased electronic ticket.

The invention relates to a method according to the preamble of patent claim 1.

For the billing of costs for transportation using public transportation such as bus, train or streetcar, two conventional methods are known: purchasing a ticket onboard during the ride with the aid of the conductor and purchasing a ticket before the ride at a ticket vending machine or from a person at a ticket window.

In both cases, the destination location or at least the region of the destination location must be provided. The system in which a ticket could be purchased from a conductor onboard during the ride has virtually disappeared since the costs for the conductor were saved. More widely established, on the other hand, is the system in which the ticket is purchased before the start of a ride from a person at a ticket window or from a ticket vending machine.

One disadvantage of the ticket window run by a person is the relatively high personnel expenditure. The disadvantage of ticket vending machines, on the other hand, is their complicated operability, and specifically in cases where different route fares are involved and when using different fare zones.

In subway and commuter train systems of public regional passenger transportation, moreover, so-called “check-in/check-out” ticket systems have been utilized in some countries for decades. Herein in above- and below-ground stops, barrier-gate facilities are set up for entry and exit checks, which only open after the ticket checked at a special reading apparatus has been accepted as valid.

Since the founding of the Hamburger Verkehrsverbund (HVV) in 1965 it has by now become customary in all Verkehrsverbünden (Transportation Networks) that a traveler with the purchase of a single one-way ticket at the start of a regional transportation ride can reach his destination stop in the line network of the transportation network without needing to be registered again anyplace after the start of the ride. His ticket is thus valid for a complete ride in the entire network and not only for certain subnetworks or only for certain lines, as had previously been the case. The price of the ticket depends on the distance between the departure and the destination points. Of disadvantage in this system is that the rides between departure and destination can only be checked with difficulty. The distribution of the revenues over the several members of a transportation network is also very difficult and is determined by means of statistical methods of approximation (Balzuweit, Meisel, Neubeiser, Weinhold: Einnahmen gerecht verteilt?, in Der Nahverkehr, No. 4. 2001).

The tickets previously used were most often paper tickets or plastic cards with an inserted magnetic strip. Today, instead, chip cards are more likely used which are based on RFID technology (RFID=Radio Frequency Identification). These RFID chip cards are also referred to as contactless chip cards in order to differentiate them from contact chip cards. RFID chip cards communicate with their reading apparatus via radio. In contrast, contact chip cards must mechanically contact with their contact face the contact face of a reading apparatus in order to conduct the necessary data exchange. The RFID technology can also be installed in a cell phone which allows the cell phone to be utilized like a contactless chip card.

A ticket system based on RFID is also already known that is employed in London and that can also be applied when changing from a subway network to a bus network (Siegfried Holz: Gibt es alternative Lösungen zu Check-in/Check-out Systemen?. Internationales Verkehrswesen (58), 5/2006, pp. 206-210).

For bus lines and subway lines entirely separate fare tickets exist, which, however, can be entered into the so-called “Oyster” memory. There are also commutation tickets for several time periods such as tickets good for a day, a week or a month, etc. as well as prepaid tickets and tickets good for multiple rides as well as personalized and anonymous tickets. In spite of the different types of tickets, the handling of all Oyster ticket types is conducted uniformly at so-called Smartcard readers.

When entering a subway station, a “check-in” of the chip cards at a Smartcard reader must be carried out, and when leaving a subway station, a “check-out” of the chip cards must be carried out at a Smartcard reader. When entering a bus, a “check-in” of the chip cards must also be carried out at a reading apparatus.

The revenues gained for the bus and subway rides must subsequently be so apportioned that train and bus operators are compensated equitably. The apportionment is calculated on the basis of the documented origin-destination relation. For this purpose the stop number of the access stop in the network is intermediately stored on the RFID chip card until the end of the ride.

Of disadvantage in this Oyster card system is that it requires barrier-gate facilities in the subway and commuter train stops, which, for example, do not exist in Germany. Subsequent installation into underground stations, most of which were built between 1970 and 1990 in Germany, is hardly feasible. Installation into busses or street cars, however, would be conceivable.

It is further known to purchase tickets using cell phones (KR 10200000 7062 A). With this system of purchasing tickets, however, it is not possible to distribute the revenues onto different transport operations.

This applies also to the cell-phone tickets offered by the German Bundesbahn. Using a WAP-capable cell phone it is not only possible to display not only travel connections and to reserve seats but also to book tickets up to ten minutes before departure, which are sent to the cell phone via MMS (Multimedia Messaging Service). These tickets comprise a bar code which the train attendant can read using a scanner.

Further known is a seat guidance system with which a ticket can be checked and guidance to a seat can take place (JP 2006018550). When a ticket or reservation ticket is bought, a reservation management system assigns train information to a travel-distance specification and sends an electronic ticket to a cell phone connection. When a user carrying a cell phone with an electronic ticket passes through a gate, for example of a subway track, information about the position of the passenger and his seat are transmitted to the reservation management system from apparatus located in the proximity of the gate. Boarding position guidance information is transmitted hereupon either to the cell phone or to a display panel in the vicinity of the user. This system also requires gates through which a passenger must pass.

There is also known a method for detecting, charging and blocking services which start for a customer when entering a service installation, for example a public transportation means, a parking place check system or a checked events venue, and which end for this customer upon leaving these service locations (WO 00/31691). On entry, customer data are acquired, which are stored on an identification card of the particular customer. However, apportioning charges to different institutions of the public road traffic does not take place.

In addition, a method for electronic payment for use of a transportation means is known, in which an end device of a cellular radio data transmission network is employed (EP 1 304 670 A1). The end device, for example a cell phone, includes a cellular radio interface as well as also a local interface, for example a Bluetooth interface, for the local data transmission. Between the cell phone and a service provision calculator a proximity data transmission connection is set up across the local interface. Across the proximity data transmission connection utilization data are transmitted from the end device to the service provision calculator. Utilization data comprise the boarding location and/or the deboarding location and/or the number of passengers and/or a number of fare zones. Yet no way is indicated of the manner in which during the travel with different public transportation means the travel costs are apportioned among the different operators of the public transportation means.

There is furthermore also known a method and a system with which an electronic registration when using public transportation means is possible (WO 01/69540 A1). Herein the traveler carries with him a cell phone which includes identity data. With this cell phone it is possible to communicate with the local communication infrastructure which is coupled with a corresponding public transportation means. The known method includes the following steps: automatic registration of the identity data of the cell phone at the start of the ride, automatic registration of the identity data at the end of the ride, automatic registration of further data of the cell phone regarding the leg traveled and the time between the two registrations of the identity data, and exchange of the registered data with a remote processing means.

There is also known a server for billing of a passenger transportation means of a mobile communicator utilizing a radio network, wherein the server is connected to a data network and includes a means for receiving a utilization request sent by the communicator, which request contains origin data (DE 101 47 788 A1). The server determines herein electronically by means of the origin data and of the radio network the local position of the communicator. Moreover, it creates a digital ticket from the utilization request and the position, which ticket is further processed according to the employed control and billing methods. The server, lastly, sends a handshake signal to the mobile communicator.

The known system consequently rests on the precise position determination of start and end stop of a ride and on a dialog regarding such between the mobile device and a server during the ride. The ticket or the temporary ticket serves as temporary access authorization, wherein this ticket is only issued after a check of identifying data and after the position determination of the boarding stop. In addition, the position of the mobile device is reported back to the same. Before the return and confirmation of the correct dial-in, a fare, if indicated also a temporary fare, is selected. During the automatic position acquisition of the transportation services, continuous monitoring is carried out of the current position from the mobile device in relation to possible transportation services during the ride. This monitoring takes place online with an acknowledgment to the communicator. For the position determination two variants are provided. In the first variant the communicator requests its position from the radio network operator, while in a second variant the mobile communicator sends a message to the server. This server subsequently determines its position on the basis of the identification of the communicator and sends it back.

In another method for the transportation expense levying for a route network with the aid of a multiplicity of user-end mobile devices and a provider-end central computer, the mobile devices and the central computer are equipped for a data exchange across a mobile radio network and the mobile devices for the acquisition of data with respect to their instantaneous position (WO 03/063088 A2). Based on a multiplicity of sequential instantaneous positions of the mobile device, a route protocol is established and this is utilized for levying the fare.

To initialize the fare levying, the central computer is contacted by a mobile device and therewith an automated dialog between mobile device and central computer is initiated. In this dialog the central computer conveys to the mobile device combinations of control positions, relevant to the instantaneous position of the mobile device, as well as a time limit. The mobile device, in turn, conveys to the central computer agreements between its instantaneous position and one of the relevant control positions or a time-out signal together with its instantaneous position. The automated dialog is at least maintained until the transmission of a first time-out signal or until agreement is reached of the instantaneous position of the mobile device with an appropriately marked position.

Thus a mobile device and a central computer communicate with one another across a mobile radio network and do so in both directions and based on an encrypted data exchange. The mobile device is appropriately adapted for this purpose and additionally equipped for the acquisition and temporary storage of data. In addition, the data with respect to the instantaneous position of the mobile device are stored in the mobile device itself. The data are compared in real time and in the mobile telephone itself, which for this purpose must store in the mobile telephone appropriate data over the route network. The position determination is carried out by means of GPS or A-GPS. Alternatively, more precise position data are determined from the mobile radio network in the form of a cell identity combined with timing advance or E-OTD.

Lastly, there is also known a method for the transmission of information regarding a mobile connection, in which, first, at least the position of the mobile connection is determined and subsequently the information is selected according to the position. The selected information is then transmitted to the mobile connection, where it is processed (WO 2005/094109 A1). In the known method the position determination consequently takes place on the basis of the information, and specifically in the summary analysis of three reference values: base station, reference stations and mobile device. The position of a terminal is determined over three reference stations and therefrom the distance of the mobile terminal from the base station is derived. Due to the movement of the mobile terminal, this distance changes continuously.

The invention addresses the problem of providing a method with which certain positions within a district can be identified.

This problem is resolved according to the features of patent claim 1.

The invention consequently relates to a method with which the local travel itinerary of a user of several different public transportation means can be ascertained. Based on this ascertained travel itinerary, the fares can subsequently be equitably distributed onto the individual operators of the transportation means. Comparison of the coordinates of stops of the public transportation means with the coordinates of base stations for transmitting and receiving operation in the mobile radio (GSM=global system for mobile communication) forms the bases of the method. These coordinates need only be deter mined once and can be stored in a memory. If the coordinates of a base station into which a cell phone is logged, are close to the coordinates of a stop, it is assumed that the user of the cell phone is located at this stop. During the ride of the user of the public transportation means the base station into which the cell phone is logged is determined at regular intervals, for example at intervals of 30 seconds. Subsequently a determination is carried out of the stop that has the shortest distance from the just activated base station, and a conclusion is drawn regarding the line on which the user is riding. Since the basic method is still afflicted with imprecisions, additional measures can be taken to render more precise the route of the cell-phone carrying user. Comparison of an official timetable with the measured time and location information represents, for example, such a measure. Utilizing certain steps of the method, it is also possible to check whether the owner of the cell phone is holding a properly acquired electronic ticket by transmitting, for example, an MMS to the target cell phone. The confirmation can also be carried out through an SMS or a data telegram via GPRS or UMTS and be conveyed parallel to the control system.

The advantage attained with the invention comprises in particular that it can be determined with the aid of an analysis of the coordinates of positions and of the coordinates of base stations, where the position with high probability is located. The positions are herein preferably such which the cell phone of a traveler assumes during a ride with the aid of public transportation means. At the start of a ride, the logged-in cell phone is logged into a first base station, and at the end of the ride, into an nth base station. Over the course of the ride the cell phone can be logged into second, third, etc. base stations. By repeating step d) of the method according to claim 1 at predetermined intervals, the itinerary of the cell phone owner can be determined. Based on this itinerary, in turn, can be determined which fraction of the transportation costs is to be allotted to a specific public transportation means if the traveler has utilized several public transportation means.

Steps a) and b) of the method must only be carried out once, or they can have already been carried out before the identification proper of the position takes place. It is consequently feasible that public transportation systems of several providers can be utilized by a participant without making an advance payment. To do so, the participant only needs to enter a command into his cell phone at the start and the end of his ride.

One difference between the invention and WO 2005/094109 A1 is that the invention comprises only two reference values—reference station (=transmitting and receiving stations of the mobile radio) and mobile device—are of significance. In addition, no data are processed in the mobile device. Knowledge of the absolute distance of the mobile terminal from a base station is not required in the invention. The position determination takes exclusively place in the base station.

One difference of the invention compared to DE 101 47 788 A1 comprises that in the invention the ongoing radio dialog of the mobile device with the radio network is utilized and the itinerary is determined subsequent to the ride. In the invention there is also no fare selection made at the beginning of the method. The fare determination rather takes place after the ride in the public transportation system. In the method according to the invention continuous acquisition of data is carried out, which data overall allow a conclusion regarding the itinerary in the public transportation system. The position acquisition thus takes place exclusively after the ride.

Moreover, in the invention commercially available mobile communicators without modification are utilized. Furthermore, in the invention dialing into the system takes place online; all other steps proceed offline and offset in time without loss of quality. The departure station does not need to be determined at the beginning of the method according to the invention. It also does not require any manual actuation by the passenger during the use of the public regional passenger transportation. Fare queries at the start of the ride are also not planned. It is likewise not necessary to consult fare tables stored in the mobile device.

One difference of the invention from the subject matter of WO 03/063088 A2 comprises that commercially available mobile devices without adaptation and without additional equipment can be employed. In addition, the mobile device does not obtain and store temporarily any data, in particular no position data of the mobile telephone itself. The invention rather rests on a non-exact comparison of position data of the mobile device with data of a start/end position of the route network. The position determination is conducted in offline operation, thus arbitrarily offset in time with respect to the actual travel time and outside of the mobile telephone. The invention also does not provide position determination of the mobile device by means of geodesic or GPS-based data. Rather, it is carried out on the basis of the data protocol of the signals received from the mobile telephone by one or several mobile communication stations and therein utilizes preferably the evaluation of the cell ID of the mobile communication stations which are in radio contact with the mobile device. The method can be expanded by utilizing the field strength differences between the mobile device and the transmitting/receiving devices by means of data currently stored in conventional manner in central control units at the network operator. No other data are measured, i.e. the process proceeds offline in central control units. The invention does not supply at any time a position of the mobile device which is exact in geodesic view. Rather, it is based on a theoretical probability approach, with the aid of which the most probable position of the mobile device is determined, which, in turn, is compared with exact network data. The method according to the invention is a multistage method and, by means of increasing precision, increases the statistical probability, such that the method does not determine exact positions, however, instead, yields sufficiently precise positions.

Embodiment examples of the invention are shown in the drawing and will be described in further detail in the following. In the drawing depict:

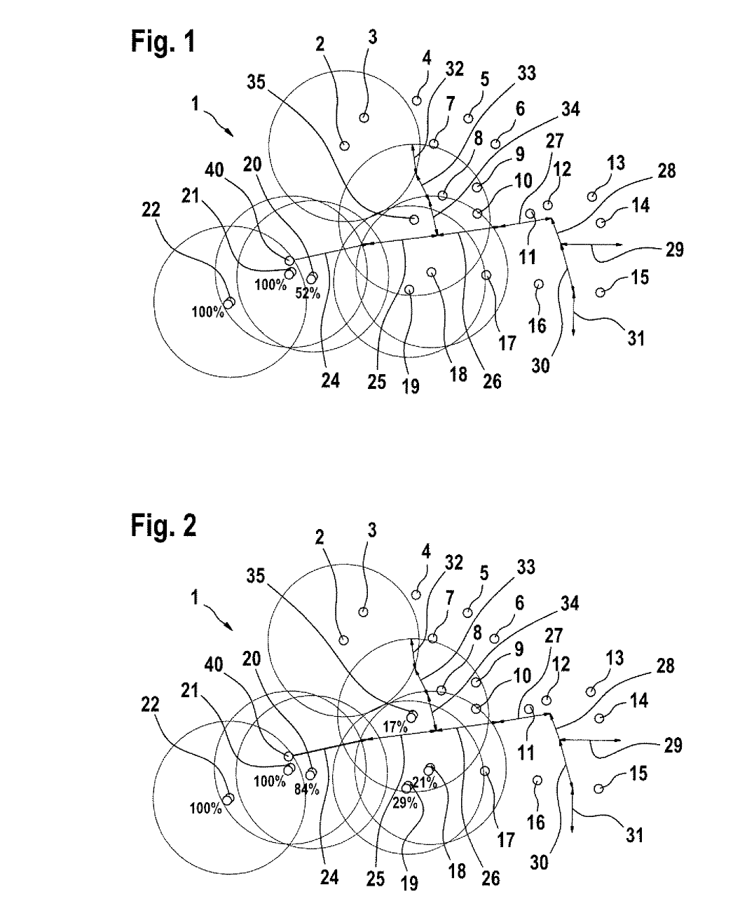

FIG. 1 a depiction of stops of public transportation means as well as of base stations for transmitting and receiving operations in mobile radio communication (BTS—base transceiver station) within a transportation network;

FIG. 2 a depiction of travel legs of public transportation means as well as of BTSs within a transportation network;

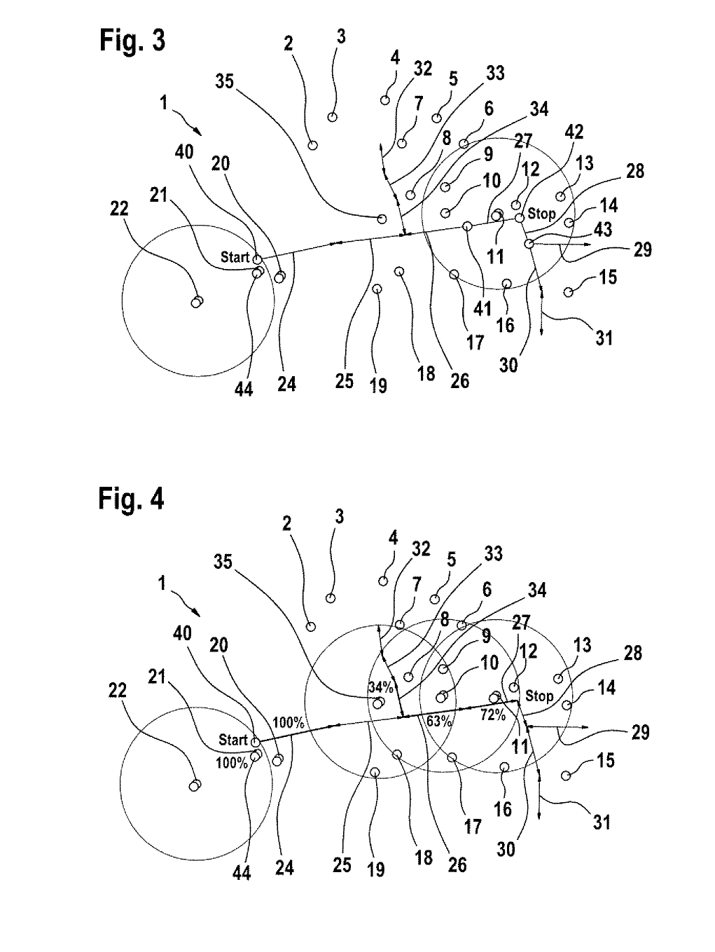

FIG. 3 start-destination relationships within a transportation network as well as BTSs;

FIG. 4 a depiction of detected sections of a ride with public transportation means of a transportation network;

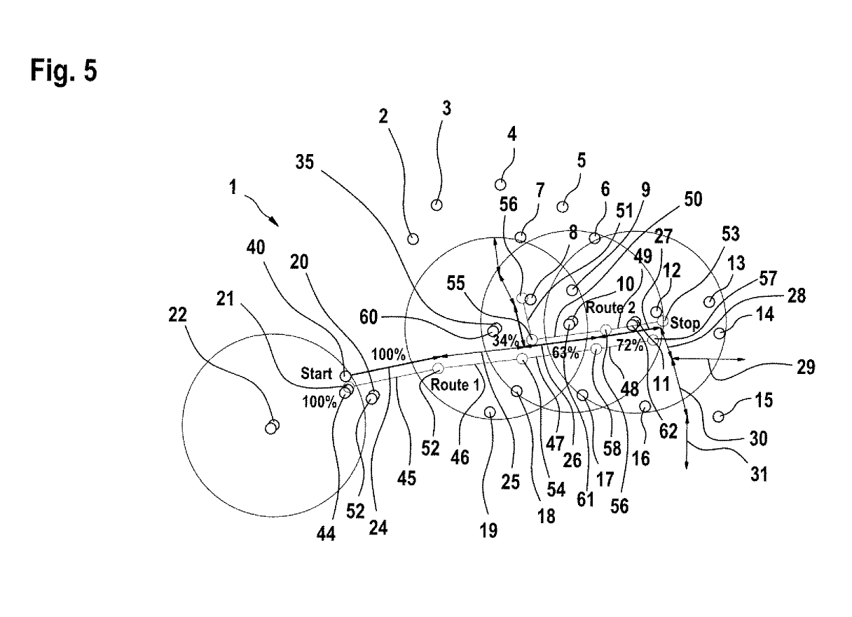

FIG. 5 a depiction of two parallel coursing routes;

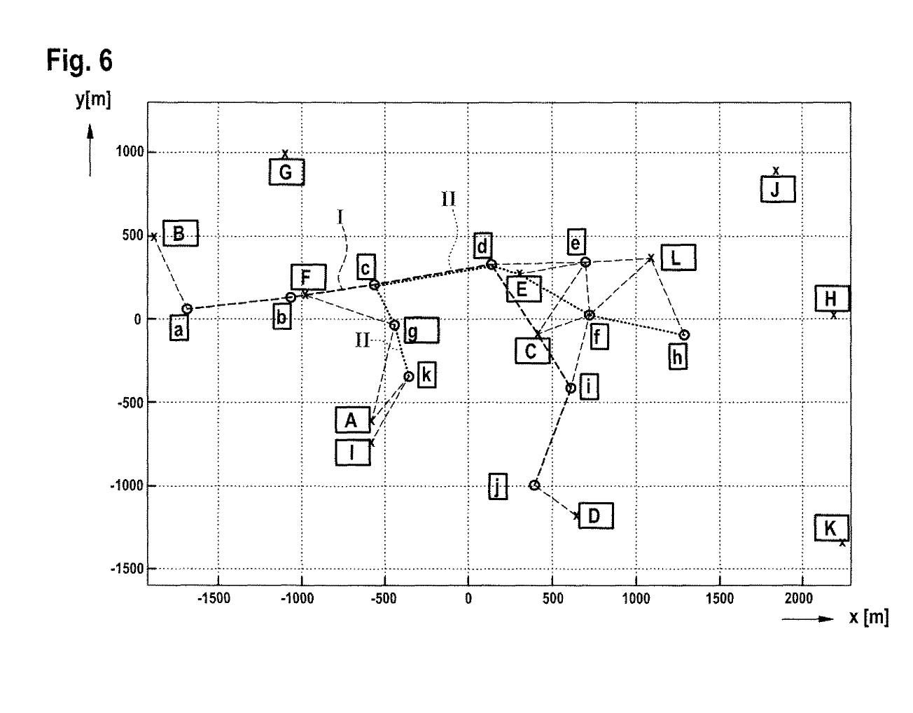

FIG. 6 a mapping depiction of the locations for base stations, stops and connections;

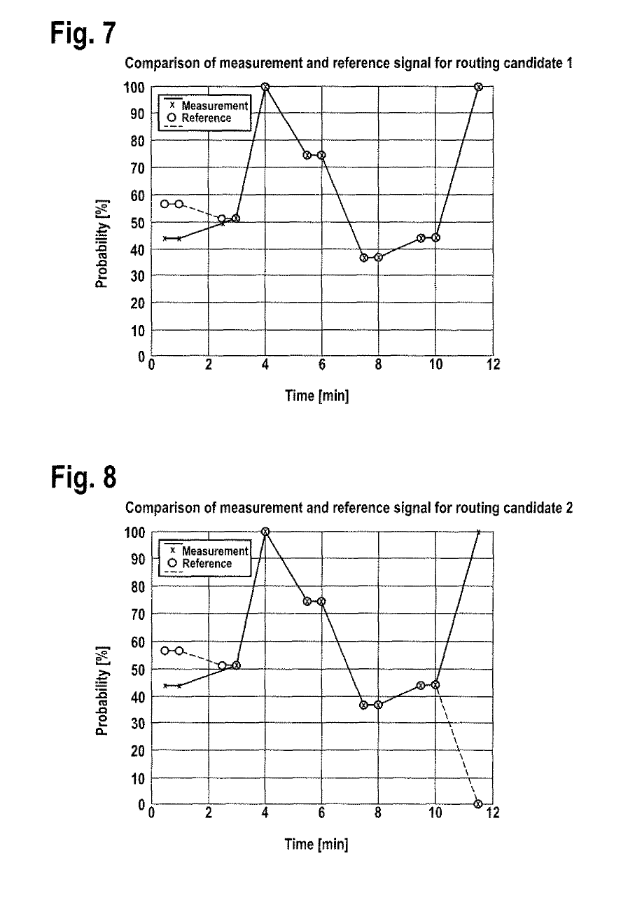

FIG. 7 curve representation of probabilities over time, wherein for a first routing candidate measured and reference signals are compared with one another;

FIG. 8 curve representation as in FIG. 7, however for a second routing candidate;

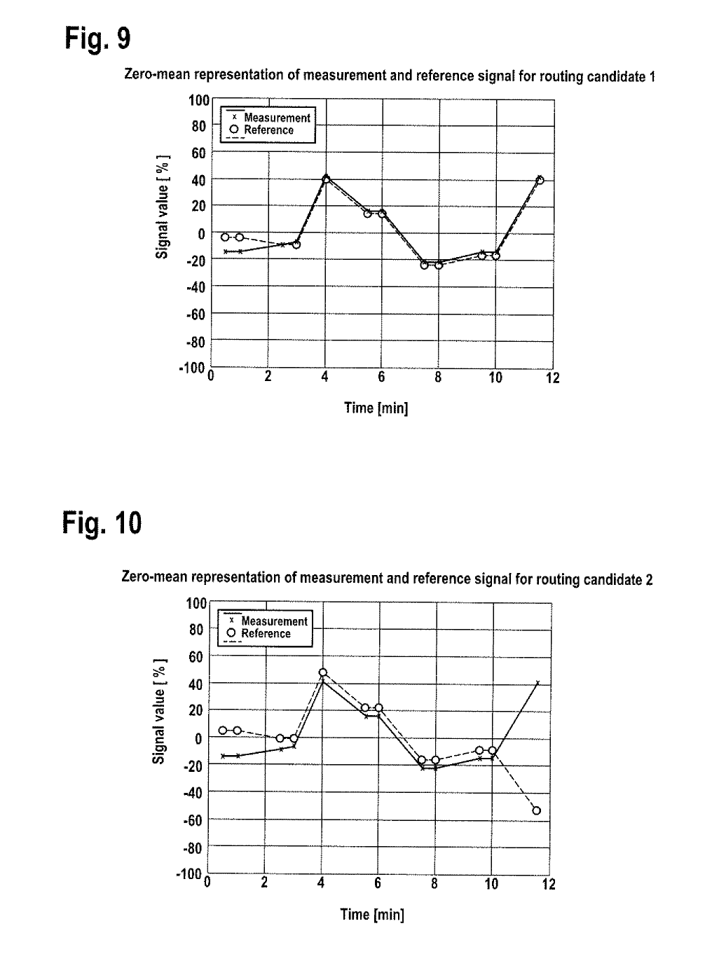

FIG. 9 signal values over time of zero-mean measured and reference signals for a first routing candidate;

FIG. 10 curve representation as in FIG. 9, however for a second routing candidate;

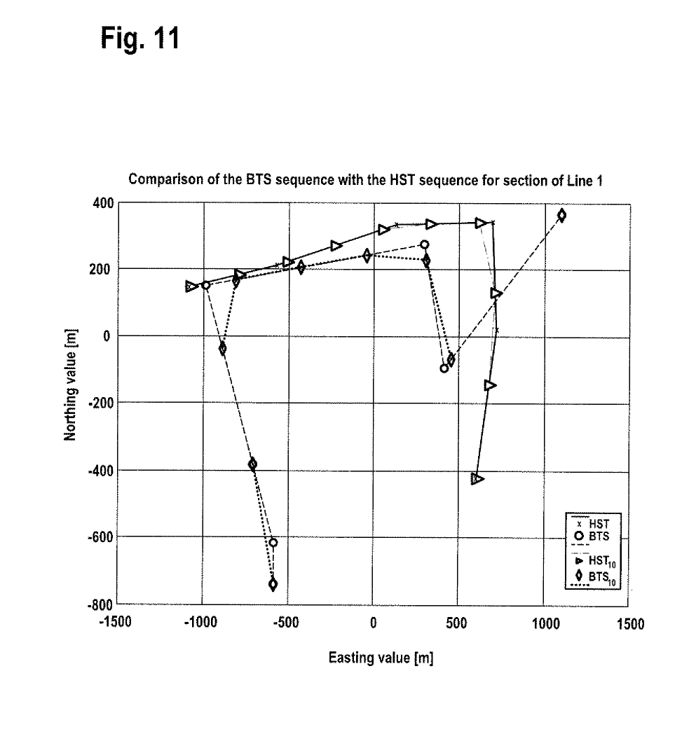

FIG. 11 northing [y-axis] values over casting [x-axis] values for BTS and HST sequences for a first transportation line;

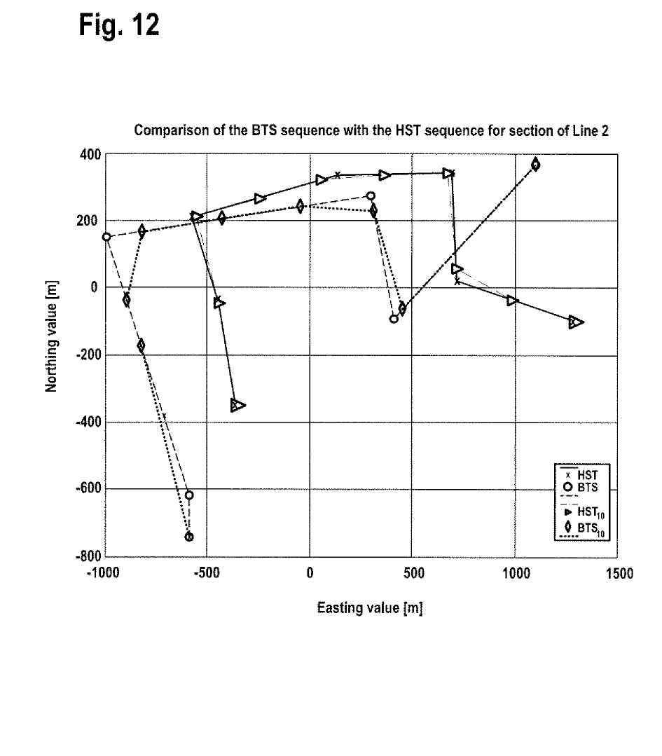

FIG. 12 values as in FIG. 11, however, for a second transportation line;

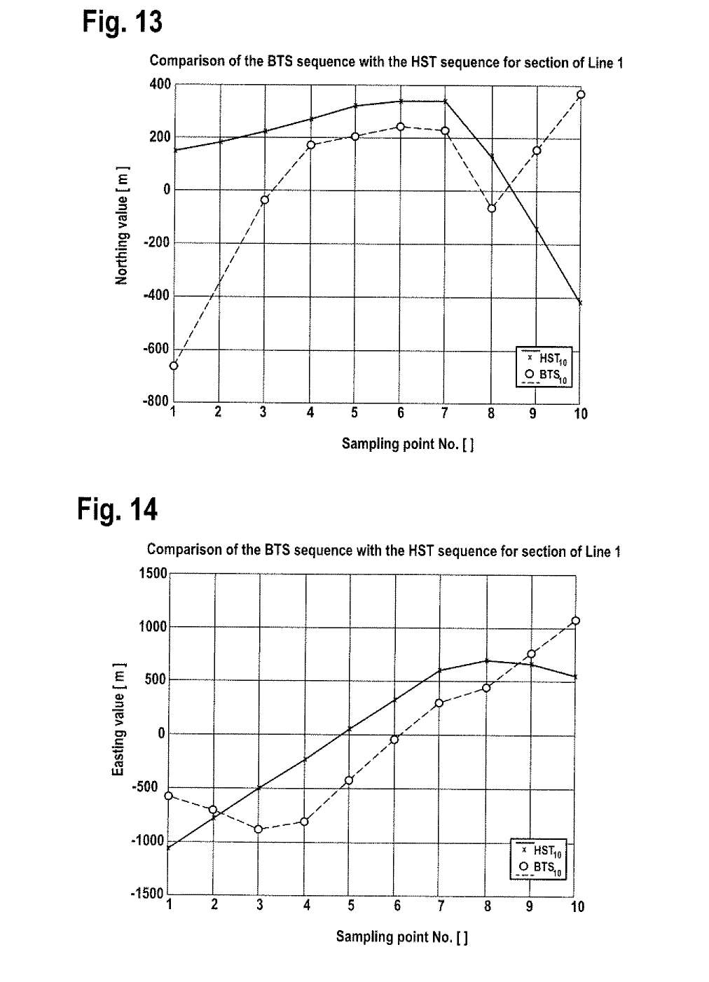

FIG. 13 northing values over sampling points for BTS and HST sequences of a first transportation line;

FIG. 14 easting values as in FIG. 13, however for other extents;

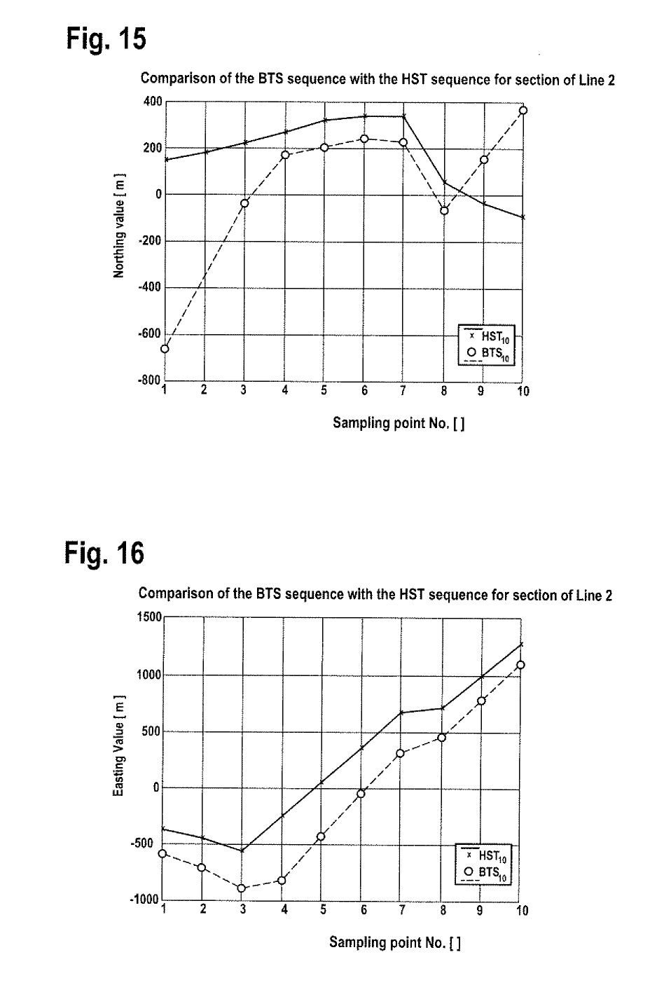

FIG. 15 northing values as in FIG. 13, however for a second transportation line;

FIG. 16 casting values as in FIG. 14, however for a second transportation line.

In FIG. 1 is shown a district 1 in which several public transportation means are provided in which several base stations 2 to 22, 35 for transmitting and receiving operation in mobile radio communication are located. The travel legs of the lines of the public regional passenger transportation (ÖPNV) are shown as arrows or double arrows, for example as arrows or double arrows 24 to 34. Each stop is wherever two arrow points abut.

The circles about the base stations 2, 35, 22, 20, 21, 18, 19 indicate the range of the transmission signals of these base stations. As a rule, all of the depicted base stations 2 to 22, 35 are operated by the same provider. In the district 1, however, it is entirely possible for base stations of other providers to be located.

If it is assumed that a user of a public transportation means is located at point 40 and that his cell phone is switched on, the cell phone is probably coupled into the base station 21 since this is the nearest base station. In this case there is then established a two-way connection between base station and cell phone via electromagnetic waves. While the physical conditions in wireline networks are clear and comprehensible and can be relatively simply calculated, the propagation of electromagnetic waves in free space is exceedingly complex. As a function of frequency and the wavelength connected thereto, electromagnetic waves propagate as ground waves, surface waves, space waves or direct waves. Correlated with the propagation is also the range, thus the distance, at which a signal can still be received. It generally applies, the higher the frequency of the wave to be transmitted, the shorter is its range.

A further factor determining the range of electromagnetic waves is their power. The field strength of an electromagnetic wave in free space decreases inversely proportionally to the distance from the transmitter. The receiver input power therefore vanishes with the square of the distance. The properties of the atmosphere vary due to weather conditions, whereby the propagation conditions of the waves also change. The attenuation is frequency dependent and has a very strong effect with some frequencies and scarcely any with others. The wavelengths that have been used and are still used in Germany for mobile radio communication networks are approximately 150 MHz (analog A-network and analog B-network), 450 MHz (analog C-network). These frequency ranges are used for data-, audio- and video-wireless communication and form space waves. Since 1992 there is the digital D1 network according to the European ETSI/GSM standard (ETSI—European Telecommunications Standards Institute), and since 1993 the digital D2 network as spatially inclusive and comprehensive GSM network (GSM=Global System for Mobile communication). The E1 network according to ETSI/DCS 1800 standard was established in 1995 as a further inclusive and comprehensive mobile communication network. The GSM frequencies lie between 890 and 915 MHz (GSM-900) and 1710 to 1785 (GSM-1800). GSM-900 and GSM-1800 are most frequently used worldwide, although there are also other frequency bands, for example GSM-400 or GSM-850. The radio link from the cell phone to the base station (=uplink) has a slightly different frequency than that from the base station to the cell phone (=downlink).

Conventional communication networks, in which attempts are made to cover a large area through high transmission power of individual base stations, are only capable of serving a limited number of subscribers due to the bandwidth utilized, because it must be avoided that two or more subscribers talk on the same frequency and can thus overhear each other. In radio communication networks with high transmission power an assigned radio contact is maintained as long as possible even if another service area has already been reached. Since the boundaries of a service area are spatially imprecisely defined, bordering service areas must use different radio communication channels to avoid interferences. At high subscriber density, this leads to an enormous frequency requirement, which, however, is limited by the scarcity of the available spectrum.

Poor utilization of the frequency spectrum in such radio communication networks and increasing numbers of mobile communication subscribers with which this system could no longer cope, led to the introduction of cellular networks. Cellular radio communication networks are based on the division of an overall area, on which the network is operated, into so-called radio communication cells, each of which is serviced by one base station.

The circles depicted in FIG. 1 represent schematically such radio cells. Each base station must only use a portion of the total available frequency channels which, in order to avoid interferences through bordering cells, can only be used again at a sufficiently large distance.

In the case of cellular networks there is thus an attempt made through low transmission power of the base station, to utilize the associated frequencies as much as possible only in the fixedly defined area of the radio cell, whereby these frequencies can be utilized again after predictably geometric protective interspaces. Those base stations whose circles overlap (for example base stations 18 and 19) should therefore have different frequencies. In contrast, base stations 14 and 22 can have the same frequencies again.

For better utilization of the available frequencies it is feasible to interlace, specifically by means of time division multiplexing or code division multiplexing, several subscriber signals on one frequency.

In practice, several base stations are combined into so-called clusters within which each frequency can only be used once. A cluster adjoins adjacent clusters in which the frequencies can be repeatedly used. The clusters must cover the entire area to be serviced, which is the reason why only certain possible cluster arrangements of, for example, 3, 4, 7, 12 or 21 cells result. The cell size can be adapted to the traffic density. To increase the subscriber capacity, in metropolitan areas there is a transition from the large cell technique to the small cell or micro-cell or pico-cell technique. Large cells have a radius of approximately 30 km, small cells to below 10 km and micro-cells of several 100 m to approximately 1 km. Pico cells have a radius of several 10 m up to several 100 m.

When a cell-phone user leaves point 40 and moves into the vicinity, for example, of base station 35, base station 35 assumes the radio contact with the cell phone, whereas the base station 20 is no longer responsible. This procedure is called handover. The preparation of a handover rests on the continuous observation and evaluation using measurement techniques of the receiving condition through the particular base and mobile stations and makes decisions regarding the spectral efficiency of the radio network and the service quality perceived by the subscriber. If, therefore a mobile subscriber leaves the service area of a base station, he must be serviced by another adjacent base station in order for the connection not to be interrupted. A connection interruption (cut-off or call drop) during a call is not accepted by the subscriber or only very unwillingly and therefore carries much weight in the definition of the service quality. Without automatic handover the subscriber or the mobile station would be forced to set up the connection anew. As the criterion for a handover in the GSM system the loop running time through the base station is measured and corrected such that the distance of the mobile station from the base station is known and a handover can be initiated in time if the subscriber leaves the planned service area, thus the cell, and another suitable base station is available.

In order to obtain the information necessary for a handover, parameters are measured by the cell phone during a connection and reported to the network. A so-called measurement protocol is sent to the network. This measurement protocol not only contains parameters of the current network connection, but also the radio conditions to adjacent cells which possibly come into consideration as a target cell in the case of the handover.

When a subscriber boards for example a streetcar at position 40, he presses a certain button on his cell phone. The base station 21, into which the subscriber is coupled, recognizes hereupon that the subscriber starts a ride with a public transportation means and forwards the corresponding information to a data processing facility of the provider. Instead of a provider, another entity can also be provided which operates the data processing facility. For example, any user of the method according to the invention can operate the data processing facility. However, this presupposes that the processes can be transacted decoupled from the data processing facility of the mobile radio network operator. This data processing facility includes a data base, in which the relations between the base stations and the stops are stored. In the data base are stored the percentage numbers of the probability with which a stop is assigned to a base station. The basis are the geo coordinates of the stops and of the base stations as well as the particular distances between base station and stop. Stop 40 lies within the wave propagation circles of three base stations, namely the base stations 20, 21 and 22.

As depicted in FIG. 1, the base station 21 is assigned to stop 40 with a probability of 65%. In the case of the base station 20, there is only a probability of 25%, while for base station 22 there is even only a probability of 10%. The percentage numbers are a basis for the calculation of the degree of confidence; they relate to the probability that the cell phone is logged into a BTS under the condition that the cell phone is located at stop 40.

However, for the present problem the converse relation is needed, namely at which stop is the cell phone located if it is logged into a certain BTS (measurement value). If the cell phone is logged into BTS 22, then the stop must be stop 40. This statement can be made with a probability of 100%. If, on the other hand, the cell phone is logged into BTS 35, several stops come into consideration with different probabilities.

Since the data processing facility of the provider knows from which base station originated the information about the boarding of the subscriber into the streetcar, it can assume that if the information originated from base station 21, it involves with a probability of 100% the stop 40 since, within the range of view of base station 21, there is only located the stop 40. Consequently, the subscriber can only be at stop 40. Since it cannot be excluded that the cell phone of the subscriber is coupled into base station 20 or into base station 22, the data processing facility of the provider knows that in these cases the subscriber is only located with a probability of 52% or also with 100% at stop 40. An accuracy of 52% under certain geometric conditions is too low to identify a stop with sufficient certainty.

Therefore a further data base is provided in the data processing facility, in which are stored the relations between the base stations and the travel legs. The manner in which these relations are determined will be described in conjunction with FIG. 2 and only in conjunction with travel leg 24.

Once the subscriber has boarded the streetcar at stop 40 and is now riding along the travel leg 24, the cell phone of the subscriber can theoretically be coupled into six base stations, namely into all base stations whose transmission circles encompass or are tangent to this travel leg 24. These are the base stations 18, 19, 20, 21, 22 and 35.

If the cell phone of the subscriber is coupled into station 18, the probability is 21% that the cell phone is located on travel leg 24. This probability for the identification of travel leg 24 is 29% in the case of a coupling into station 19, 84% for a coupling into station 20, 100% each for a coupling into station 21 or 22 and 17% in the case of coupling into station 35.

The particular calculated probabilities are based on the mean distance between a travel leg and a base station. The mean distance is determined, using a geometric standard method from coordinates of the start and end point of the travel leg and the coordinates of the base station. The coordinates of the base station can be charted for example with the aid of GPS or Galileo, which evaluates the signals of a satellite-supported system for worldwide localization and location determination. The coordinates of the individual stops can be stored in a memory in the same manner.

Analogously to the probability values of the travel leg, the probability values for the remaining travel legs 25 to 30 and 32 to 34 are also stored in the memory of the data processing facility. These calculations are only carried out once before application of the system according to the invention.

In a further step are now converted the probabilities that a cell phone is logged into a BTS under the condition that a certain leg is being traveled. The goal are new probabilities that a cell phone is moving on a travel leg under the condition that it is logged into a specific BTS.

Consequently, there are two sets of data available: one data set which assigns the individual stops to the individual base stations, and one data set which assigns the individual travel legs to the individual base stations, with the assignment being expressed as a percentage.

When the subscriber travels along leg 24, the base station 20 after a certain time accepts him from base station 21 with a relatively high probability. Based on the change from base station 21 to base station 20, the conclusion can be drawn that the subscriber is located on travel leg 24. If the subscriber now continues with the same streetcar on travel leg 25, he will be taken over by base station 35 after a certain length of time. In the data processing facility of the provider the transition from base station 20 to base station 35 is detected. Based on this transition, it can be concluded that the subscriber is located on travel leg 25.

If the subscriber deboards the streetcar at the end of travel leg 25 and boards a subway which travels along travel leg 34, his cell phone is initially still coupled into base station 35. Since, when transferring, the subscriber does not again press a button on his cell phone, the data processing facility of the provider knows neither anything about the transfer of the subscriber nor that he is now on board the subway and on travel leg 34.

When the subscriber ends his ride at the end of travel leg 34, he again presses the button on his cell phone. The data processing facility now knows that the subscriber has terminated his ride. It also knows that the cell phone of the subscriber is still coupled into base station 35. Based on the probability data, which are assigned to the stop at the end of travel leg 34, and based on the probability data which are assigned to travel leg 34, it can be concluded that the stop at the end of travel leg 34 is involved. Therewith the entire travel route of the subscriber has been determined.

Not yet determined is the ÖPNV offer of which the subscriber has availed himself. It is especially difficult to determine the ÖPNV offer utilized, if several ÖPNV offers are available in parallel on individual path legs.

In the following a simple algorithm is described in conjunction with FIG. 3. In this algorithm a few accesses suffice to the data base in which the percentages of the stops, as depicted in FIG. 1, are stored.

The subscriber again boards at start point 40. He has previously pressed a special button on his cell phone or has conducted a speed dial to actuate an electronic ticket. The message is transmitted to the provider via mobile radio communication. The provider returns a corresponding response protocol such that the subscriber receives a recognition on the display of his cell phone. The log-on process can proceed in different ways: the log-on can take place, for example, via SMS or MMS or per call to a call center. It is also feasible to send data telegrams per GPRS or UMTS (=Universal Mobile Telecommunications Service) to the provider. If a stop is equipped with special techniques for proximity range communication (for example WLAN Wireless Local Area Network, UWB, etc.), the log-on procedure can be carried out across these communication channels.

At the destination 42 of his ride, the passenger logs out again in the same manner. The log-out of the passenger is not obligatory for the mode of operation of the method. Should the passenger forget to log out, the invention is capable of detecting in a multistage process the end of the ride itself.

In the assumed case the base station 21 is only assigned to one stop 40, which makes it clear to which ÖPNV provider this stop 40 is assigned. At the destination location 42 the base station 12 is also known. Within the transmission circle of this base station 12 there are, however, three stops, namely the destination station 42 itself and the stations 41 and 43. These are all located within one fare zone of the ÖPNV such that a unique assignment is not possible when taking exclusively the destination station 42 into consideration. This assignment, however, becomes unique if the documented travel path from station 40 to the destination station is compared against all possible timetables for rides from station 40 to the possible destination stations 41, 42 and 43. As a rule, only one station in the pattern of the stop sequence and the travel time is going to correspond to a given timetable. In those cases in which no unique predication is possible since, for example, all arithmetically possible destination stops 41, 42 and 43 are assigned to the same line path, the actual destination stop can be neglected since this ride in all three cases is assigned to the same operator and, as a rule, such stops located in close proximity can be assigned to one fare zone. Since today, except for a few, very rare cases, the fare is charged according to fare zones, the fare in these cases is identical for a ride to all three destination stops.

If the determined quality for a calculated ÖPNV travel leg is not sufficient, a detailed process is applied which will be explained in further detail in conjunction with FIGS. 4 and 5.

It is assumed that the stop 40 and the travel leg 24, 34, 26 and 27 have already been detected for a first route.

The example of FIG. 4 shows the manner in which the measurement of a BTS through the percentage numbers can be assigned to a travel leg or to a stop. Such quantities are reproduced in Table 5 shown below. These percentage numbers effectively represent indices of a travel chain. Individual indices can be erroneous, however, these errors can be progressively compensated through the complete processing of indices chains. FIG. 4 shows the manner in which the indices are distributed and that there are contradiction and discontinuities with respect to the travel chain. From these indices possible candidates for the travel chain are compiled, for example one Route 1 and one Route 2, shown in FIG. 5.

In FIG. 5 a first Route 1 is provided with travel legs 45 to 48 as well as a second Route 2 with travel legs 49 to 51. The first route has four travel legs and five stops 52 to 57. The second route, on the other hand, has three travel legs 49 to 51 and four stops 52 to 56. Five detected elements of the two routes correlate with one another, namely the travel legs 47, 48 with travel legs 49, 50 as well as the stops 54, 56, 57 with stops 55, 56 and 53.

In one constellation, as is shown in FIG. 5, differentiated consideration is required since the assignment onto the two ÖPNV lines must be made with high certainty although it is not initially detectable which line the user has, in fact, selected.

During the ride along the first route the cell phone had been coupled into four base stations, namely into the base stations 22, 35, 10 and 11. The corresponding data, generated during the utilization of the ÖPNV, had been saved in a memory.

Should the detailed method also not be able to attest sufficient quality to the calculated result, in a third step, in addition to the geometric or spatial relations, the time aspects of the kinematic or spatial relations at the transitions from one base cell to the succeeding base cell are also taken into consideration. This is always the case whenever on identical path legs between identical boarding and deboarding stops different, overlapping, however time-offset, ride options offered by different transportation organizations can be utilized (for example organization A with arrival times every full and half hour; organization B with arrival times every 20 and 50 minutes of the hour). At the end of this third step of the calculation, the scenarios still not adequately resolved are stored for manual postprocessing.

In the data processing facility of the provider a module “Quality Management” is provided in which a continuous semi-automatic optimization of the algorithms and a check of the results is carried out. The quality management is closely linked to the method stage for the manual postprocessing, wherein the results with low accuracy with respect to the revenue distribution are evaluated and, if indicated, are adapted. The result of the quality management is comprised of an adaptation of the parameters in the proximity of the decision points and an adaptation to the various algorithms.

The capability and performance of these calculation steps depends inter glia also on the configuration of the fare area. There are advantageous geometries for the definition of the fare zones which can also be supported by means of a semi-automatic cluster algorithm.

In FIG. 6 is also depicted a mapping representation of the locations for base stations, stops and connections with distance specifications. Herein are evident the stop stations a to k as well as the base stations A to L. The circles, which indicate the ranges of the base stations, are omitted for greater clarity. A streetcar line I commutes between stop stations a and j. On the other hand, a bus line II commutes between stops k and h.

It may be assumed that the passenger uses only Line 2, and specifically along the stations k-g-c-d-e-f-h.

Using as a basis the mapping depicted in FIG. 6, the manner in which said path of the passenger is determined and in which subsequently the costs are distributed onto the different transportation means carriers will be described in the following.

As postulated, in a data base can be found
locations of stops (coordinates)
locations of the BTS (coordinates)
timetables with information regarding the times at stops and for the sequence in which stops are passed.

Further information, for example the geodesic course of the trajectories for individual lines, the distribution of the GSM field strengths as a map, information about time discrepancies from the particular timetables, etc. would be helpful and could optimize the result. However, they will not be taken into consideration in the following.

As measurement data the following information is required:
time of measurement (resolution 30 seconds, accuracy 15 seconds)
cell ID or number of the logged-in BTS at this time.

The sampling time is in principle arbitrary for the measurement. However, for the example described in the following, a sampling time of T=30 s is assumed. It is furthermore assumed that eleven stop stations (HST) a to k and twelve base stations (BTS) A to L are available. In the following Table the “x values” indicate the horizontal x-coordinates and the “y values” indicate the vertical y-coordinates.

TABLE 1

| Base Station BTS ID | X Value [m] | Y Value [m] |
|---|---|---|
| A | −617 | −587 |
| B | 489 | −1872 |
| C | −95 | 411 |
| D | −1171 | 639 |
| E | 274 | 297 |
| F | 151 | −987 |
| G | 981 | −1101 |
| H | 28 | 2181 |
| I | −741 | −587 |
| J | 889 | 1838 |
| K | −1325 | 2238 |
| L | 366 | 1096 |

TABLE 2

| Stop HST ID | X Value | Y Value |
|---|---|---|
| a | 59 | −1683 |
| b | 147 | −1075 |
| c | 209 | −573 |
| d | 333 | 130 |
| e | 342 | 691 |
| f | 18 | 715 |
| g | −38 | −448 |
| h | −100 | 1281 |
| i | −420 | 601 |
| j | −996 | 386 |
| k | −345 | −364 |

The coordinates of Tables 1 and 2 serve for calculating the distance and therewith for calculating the probabilities for Table 4.

Table 3 reproduced in the following depicts an excerpt from a timetable and specifically for two different ÖV [Öffentlicher Verkehr=public transportation] lines. As a simplification, the times are defined as minutes relative to a time t₀.

TABLE 3

| Stop HST ID | Departure [min] | Line No. |
|---|---|---|
| a | 15 | 1 |
| b | 17 | 1 |
| c | 19 | 1 |
| d | 21 | 1 |
| e | 23 | 1 |
| f | 25 | 1 |
| I | 26 | 1 |
| j | 28 | 1 |
| k | 0 | 2 |
| g | 2 | 2 |
| c | 3 | 2 |
| d | 5 | 2 |
| e | 7 | 2 |
| f | 9 | 2 |
| h | 11 | 2 |

From the data of Tables 1 to 3 the probabilities of a cell phone being located at stop a to k are calculated, and specifically under the condition that a certain. BTS is being received. The result of this calculation is compiled in Table 4 which shows the probabilities from the aspect of the involved BTS.

TABLE 4

| Base Station BTS ID | Stop HST ID | Probability |
|---|---|---|
| A | g | 46% |
| A | k | 54% |
| B | a | 100% |
| C | d | 13% |
| C | e | 14% |
| C | f | 22% |
| C | i | 51% |
| D | j | 100% |
| E | d | 53% |
| E | e | 26% |
| E | f | 21% |
| F | b | 40% |
| F | c | 40% |
| F | g | 20% |
| I | k | 100% |
| L | e | 22% |
| L | f | 17% |
| L | h | 61% |

In Table 4 only those BTSs are taken into consideration in whose range the HST is located. In a first step the probability is calculated that a cell phone is logged into a BTS, and specifically under the condition that the cell phone is located at a certain HST. This calculation is based on the distance between BTS and HST, which is inversely proportional to the probability. The question is asked, however, with what probability the cell phone is located at an HST under the condition that the cell phone is logged into a certain BTS. The probabilities are therefore further processed such that each BTS weights and normalizes the HST within range according to the probabilities from the first step. Therefrom result the percentage numbers of Table 4.

As stated above, it is assumed that a passenger uses only the ÖV Line 2 and does so according to the stop sequence k-g-c-d-e-f-h, wherein the passenger at the start of the ride activates the c-ticket mode and terminates it at the end of the ride. His travel through the BTS network is subsequently determined through an appropriate measuring protocol which is reproduced in the following Table 5.

TABLE 5

| Stop HST ID | | |
|---|---|---|
| (not component of measurement) | Time [minutes] | Base Station BST ID |
| k | 0.5 | I |
| k | 1.0 | I |
| — | 1.5 | A |
| g | 2.0 | A |
| g | 2.5 | A |
| — | 3.0 | F |
| c | 3.5 | F |
| c | 4.0 | F |
| — | 4.5 | F |
| — | 5.0 | E |
| — | 5.5 | E |
| d | 6.0 | E |
| d | 6.5 | E |
| — | 7.0 | E |
| e | 7.5 | E |
| e | 8.0 | E |
| — | 8.5 | C |
| — | 9.0 | C |
| f | 9.5 | C |
| f | 10.0 | C |
| — | 10.5 | L |
| h | 11.0 | L |
| h | 11.5 | L |

Table 5 indicates that based on measurements taken at intervals of 30 seconds, it was found that the BTS I communicated for one minute with the cell phone. Thereupon BTS A also communicated for one minute with the cell phone, etc.

BTS F and E were accessed by the cell phone for the longest time, namely for 1.5 minutes or 3 minutes, respectively. The left column of Table 5 serves only as auxiliary information with the particular stop when the vehicle is standing still. The dash indicates that the vehicle is en route between two HSTs.

The individual calculation methods for the determination of the utilized travel routes for the above reproduced scenario are described in the following.

### Basic Method

For the basic method the start-destination relation is determined. For this purpose, it is determined which BTS communicated with the cell phone at the time of the start of travel and which at the end of the travel. The following Table 6 reproduces the corresponding assignment.

TABLE 6

| | Base Station BTS ID |
|---|---|
| Start | I |
| Destination | L |

For these BTS numbers the possible candidates for the start or destination stops are now determined from Table 4, which leads to the following intermediate result.

TABLE 7

| Base Station BTS ID | Stop HST ID | Probability |
|---|---|---|
| I | k | 100% |
| L | e | 22% |
| L | f | 17% |
| L | h | 61% |

While for the assumed scenario the start stops could be uniquely identified, for the destination stops three possible candidates are available with are known with their particular probability values.

The overall probability for a single start-destination relation is determined from the product of the individual probabilities for each stop.

p(HSTⁱₛₜₐᵣₜ, HST^{j}_{destination})=p(HSTⁱₛₜₐᵣₜ)·p(HST^{j}_{destination})

This takes place since for the start as well as also for the destination several HSTs are possible. Hereby a matrix is generated of several start-destination relations, each of which individual relation must be documented with a probability. If the cell phone at the start had not been logged into BTS “I” but rather into BTS “A”, as the probability for HST “k” the value 54% and for HST “g”, the value 46% would be given.

For the present case the following result is obtained:

TABLE 8

| | | Destination Stop HST | | |
|---|---|---|---|---|
| | | e | f | h |
| Start Stop HST | k | 22% | 17% | 61% |

Thus from the multiplicity of possible start-destination relations, three candidates were determined as possible destinations. Accordingly, the start stop is stop k (Line 2), while the destination stop with a 61% probability is stop h (Line 2). Using these results as a basis, in a further step the accuracy is increased.

### Improvement Method

The results of the basic method serve as a basis for an improvement method, and they are now compared with the available information from the timetable (Table 3). For the start stop, i.e. stop No. k, the following entry can be found in the timetable:

TABLE 9

| Stop HST ID | Departure [min] | Line No. |
|---|---|---|
| k | 0 | 2 |

For the possible destination stops No. e, f, h, the following entries can be found in the timetable:

TABLE 10

| Stop HST ID | Departure [min] | Line No. |
|---|---|---|
| e | 23 | 1 |
| f | 25 | 1 |
| e | 7 | 2 |
| f | 9 | 2 |
| h | 11 | 2 |

For this information, permutations are also compiled and compared with the measured time. In the following Table each time specification is given in the format “(start time/destination time)”.

TABLE 11

| | | Timetable Time | Measurement Time |
|---|---|---|---|
| | | [min] | [min] |
| | | Start Stop HST ID | Start Stop HST ID |
| | | k (Line 1) | K (Line 1) |
| Destination | e (Line 1) | (0/23) | (0.5/11.5) |
| Stop HST | f (Line 1) | (0/25) | (0.5/11.5) |
| ID | e (Line 2) | (0/7) | (0.5/11.5) |
| | f (Line 2) | (0/9) | (0.5/11.5) |
| | h (Line 2) | (0/11) | (0.5/11.5) |

The value pair 0.5/11.5 in the right column refers to the time of the first measurement at the start and the last measurement at the destination. The values are taken from Table 5.

TABLE 12

| | | Time Difference | Time Differences |
|---|---|---|---|
| | | (Δt) | (Δt ≧ 1) |
| | | Start Stop HST ID | Start Stop HST ID |
| | | k (Line 1) | k (Line 1) |
| Destination | e (Line 1) | (0.5/11.5) | (1.0/11.5) |
| Stop HST | f (Line 1) | (0.5/13.5) | (1.0/13.5) |
| ID | e (Line 2) | (0.5/4.5) | (1.0/4.5) |
| | f (Line 2) | (0.5/2.5) | (1.0/2.5) |
| | h (Line 2) | (0.5/0.5) | (1.0/1.0) |

From this presentation the time discrepancies can be calculated as the difference of the measurement from the timetable. For subsequent further processing of the time differences, at this point a minimum value of 1 minute is defined and all time differences are considered without sign as discrepancy between measurement and timetable. To avoid the negative effect of singularities, in the weighting of the determined Δt values, no values smaller than 1 enter into the calculation. All values with “0”, “0.5”, etc. are rounded to “1”.

TABLE 13

| | | Time Differences [min] |
|---|---|---|
| Destination | e (Line 1) | 11.5 |
| Stop HST | f (Line 1) | 13.5 |
| ID | e (Line 2) | 4.5 |
| | f (Line 2) | 2.5 |
| | h (Line 2) | 1.0 |
| | Sum: | 33.0 |

The weights for the probable solution are inversely proportional to the time discrepancies and are calculated according to the following rule:

TABLE 14
${Weight}_{i} = \frac{{\sum }_{i} Δ {t}_{i}}{Δ {t}_{i}}$

| | | Weights |
|---|---|---|
| Destination Stop HST ID | e (Line 1) | 2.9 |
| | f (Line 1) | 2.4 |
| | e (Line 2) | 7.3 |
| | f (Line 2) | 13.2 |
| | h (Line 2) | 33.0 |
| | Sum: | 58.8 |

From the determined weights, the probabilities are calculated as proportional fraction to the single weight using the following rule:

$$p ( {HST}^{i} ) = \frac{{Weight}_{i}}{{\sum }_{i} {Weight}_{i}}$$

The following probabilities can be calculated therefrom:

TABLE 15

| | | Weights |
|---|---|---|
| Destination | e (Line 1) | 6% |
| Stop HST | f (Line 1) | 4% |
| ID | e (Line 2) | 12% |
| | f (Line 2) | 22% |
| | h (Line 2) | 56% |

While Table 13 already contains the result for the improvement method, however only those probabilities are determined by scaling and normalizing which correspond to the results from the base method. These are compiled in Tables 14 and 15.

It is evident that even after the improvement method, which actually is an alternative method, the stop h is the most probable. Since the results of the basic method and of the improvement method in so far agree, the probability, that h is the destination stop has increased.

For the start stop HST basically the same method is applied. However, in the chosen example it was not selected since the start stop could already be determined using the basic method. This method, however, always only yields 100% with one HST. Therefore a separate check of the time discrepancy is useful, which for the example scenario also delivers a strong confirmation of the selection made.

### 1. Optimization Method

In the optimization method the entire travel route is considered. It is herein assumed that the utilized ÖV connections are made according to the timetable, i.e. without delay. The method incorporates the measured BTS at each HST into the method.

With the results from the basic method and the improvement method, in which only the start and end stations as well as the lines were determined, the following routing variants are determined as possible candidates for the utilized OV connection.
Line 2: HST sequence k-g-c-d-e-f-h (routing candidate 1)
Line 2: HST sequence k-g-c-d-e-f (routing candidate 2)

The routing method itself is not subject matter of the invention since it is already known as such, for example at commercial GIS Tools—for example MapInfo—corresponding modules are available.

For the determined start and destination stations a sequence of time, BTS and probabilities is generated from the timetable (FP) and assigned to the corresponding measurement values. Herein only scheduled stops at HST are taken into consideration. In this manner, for the routing candidate 1, the following table results.

TABLE 16

| Time | HST | BTS ID | p(Measure- | BTS ID | p(Refer- |
|---|---|---|---|---|---|
| [min] | ID | (Measurement) | ment) | (Reference) | ence) |
| 0.5 | k | I | 44% | A | 56% |
| 1.0 | k | I | 44% | A | 56% |
| 2.5 | g | A | 49% | F | 51% |
| 3.0 | g | F | 51% | F | 51% |
| 4.0 | c | F | 100% | F | 100% |
| 5.5 | d | E | 74% | E | 74% |
| 6.0 | d | E | 74% | E | 74% |
| 7.5 | e | E | 36% | E | 36% |
| 8.0 | e | E | 36% | E | 36% |
| 9.5 | f | C | 44% | C | 44% |
| 10.0 | f | C | 44% | C | 44% |
| 11.5 | h | L | 100% | L | 100% |

For routing candidate 2 the following Table results:

TABLE 17

| Time | HST | BTS ID | p(Measure- | BTS ID | p(Refer- |
|---|---|---|---|---|---|
| [min] | ID | (Measurement) | ment) | (Reference) | ence) |
| 0.5 | k | I | 44% | A | 56% |
| 1.0 | k | I | 44% | A | 56% |
| 2.5 | g | A | 49% | F | 51% |
| 3.0 | g | F | 51% | F | 51% |
| 4.0 | c | F | 100% | F | 100% |
| 5.5 | d | E | 74% | E | 74% |
| 6.0 | d | E | 74% | E | 74% |
| 7.5 | e | E | 36% | E | 36% |
| 8.0 | e | E | 36% | E | 36% |
| 9.5 | f | C | 44% | C | 44% |
| 10.0 | f | C | 44% | C | 44% |
| 11.5 | — | L | 100% | — | 0% |

In the determination of Tables 16, 17 it is assumed that a new value is measured at regular intervals. These time intervals are 30 seconds in the present case. The complete list of the measurements is reproduced in Table 5.

In the columns of Table 16 and Table 17 the following values for the correlation are compiled (from left to right):
t=points in time at which a stop at an HST is scheduled according to the timetable (FP) HST of the predetermined candidate route
BTS from the measurement
probability for HST, if BTS (from column 3) is received
BTS optimally receivable at the particular HST (highest probability!)
probability for HST when optimal BTS is received (values in column 6 are greater or equal to the values from column 4). If the signals from the measurement or the candidates are of unequal length, the particular shorter signal is filled out with “0”.)

To determine the data, from the timetable are queried the arrival and departure times for each HST. A standing time of, for example, one minute at each stop is assessed.

Only the HSTs are considered. Therefore, according to the determined times from the timetable, only the measurements at the HSTs are taken into account. The corresponding measurements were extracted and entered into Table 16 and Table 17.

In the last step to the measured BTS the probabilities with respect to the HST of the measurement are entered (column 4). Furthermore, for each. HST the optimal BTS (column 5) with the particular maximal probability (column 6) is entered.

As signals for the time correlation the probabilities of the measurement (column 4) are offset against the probabilities of the reference (column 6). The corresponding curves for routing candidate 1 are shown in FIG. 7 and for routing candidate 2 in FIG. 8.

The dashed lines refer to measurements, while the solid lines refer to references. The probabilities are taken from Table 4. Consequently, it is possible to speak in FIGS. 7 and 8 of the probabilities of the measurement signal and of the reference signal.

The similarity of the two curves is determined through a correlation coefficient. For that purpose, the two signals to be compared are made zero-mean in order that the shaping of the curve form and not the absolute values of these curves are depicted through the calculation method as the dominant influence for the similarity. The resulting curves are shown in FIGS. 9 and 10. While FIG. 9 shows the curve for the routing candidate 1, FIG. 10 shows the curve form for the routing candidate 2. In FIGS. 9 and 10 the same signals as in FIGS. 7 and 8 are shown, however revised with respect to its mean value.

The zero-mean signals or the measurement and for the reference are calculated as follows:

$${mes}_{i} = {p ( mes )}_{i} - {μ}_{mes} ; {μ}_{mes} = \frac{1}{n} {\sum }_{i = 1}^{n} {mes}_{i}$$

$${ref}_{i} = {p ( ref )}_{i} - {μ}_{ref} ; {μ}_{ref} = \frac{1}{m} {\sum }_{i = 1}^{m} {ref}_{i}$$

From these signals the correlation coefficient is calculated as follows:

$$ρ = \frac{{\sum }_{i} {mes}_{i} {ref}_{i}}{\sqrt{{\sum }_{i} {( {mes}_{i} )}^{2} \cdot {\sum }_{i} {( {ref}_{i} )}^{2}}}$$

The correlation coefficient is a normalized value and has a value range of [−1, 1]. As result obtained for the selected candidate are produced the following values:
1. Routing candidate 1: ρ=0.97
2. Routing candidate 2: ρ=0.21

The difference in the signal courses at HST 8 thus effects a significant change for the characteristic from Method 3 that the similarity of the two curves falls from 97% to a value of 21%.

### 2. Optimization Method

In an alternative method to the optimization method the entire travel chain is also considered. In contrast to the optimization method, however, here only the geometric relations between the coordinates of the HST of possible travel routes and the coordinates of the measured BTS locations are compared.

This method leaves the time connections entirely out of consideration and is therewith also independent of delays or disturbances in the operation of the public transportation means. For the present calculation example, a ride with Line 2 through the following HST sequence was taken as the basis:
Line 2: HST sequence k-g-c-d-e-f-h

In differentiation of the utilized Line 2 from the Line 1 running partially in parallel, the HSTs of Line 1 are now sought out, which are located within the receiving range of the measured BTS locations. Therewith a possible ride alternative results with Line 1 which is described by the following HST sequence:
Line 1: HST sequence b-c-d-e-f-i

The geometric course of these possible travel chains must now be compared with the geometric course of the BTS sequence
Measurement: BTS sequence I-A-F-E-C-L
   from the measurement.

FIG. 11 shows as a mapping depiction the BTS sequence from the measurement and the extracted HST sequence for Line 1. In addition to the original traverses of the sequences, traverses with precisely ten sampling points (BTS 10 and HST 10) are plotted.

These additional signals (BTS 10 and HST 10) are directly derived from the original traverses and have the following properties.
The number of sampling points of the BTS sequence and of the HST sequence are identical (for the present case 10 sampling points were selected, in principle, this number can be freely selected).
The individual coordinates are calculated such that the sampling points are distributed equidistantly over the connection lines of the original sequences.
The distance of the sampling points of the HST sequence can differ from the distance of the sampling points of the BTS sequence.

The sequence of the determined sampling points consequently emulates in shape the original traverse as an approximation. Herein is involved a geometric sampling with a predetermined number of sampling points. These calculated sampling points are plotted in FIGS. 13 to 16 on the particular x-axis.

The corresponding relations for the comparison between the BTS sequence from the measurement and the extracted HST sequence of Line 2 are shown in FIG. 12.

The signals are required as input signals for the correlation calculation proper.

The similarity of the two curves is determined analogously to the optimization method through the correlation coefficient. In contrast to the optimization method, the determined mean values of the individual signals play an important role for the interpretation of the results. In FIG. 13, 14 therefore are shown the not-zero-mean signals for the comparison of the BTS sequence from the measurement and the extracted HST sequence for Line 1. Fasting value (=x coordinate) and northing value (=y coordinate) are each plotted over the sampling point number. For the comparison of the sequences with respect to Line 2 the corresponding signals are shown in FIG. 15, 16.

$$The calculation of the correlation coefficient takes place$$

$$analogously to the optimization method . The zero \text{-} mean$$

$$signals ( measurement and reference ) are calculated as follows \text{:}$$

$${mes}_{i} = {p ( mes )}_{i} - {μ}_{mes} ; {μ}_{mes} = \frac{1}{n} {\sum }_{i = 1}^{n} {mes}_{i} \\ {ref}_{i} = {p ( ref )}_{i} - {μ}_{ref} ; {μ}_{ref} = \frac{1}{m} {\sum }_{i = 1}^{m} {ref}_{i} \\ From these signals the correlation coefficient is calculated$$

$$as follows \text{:}$$

$$ρ = \frac{{\sum }_{i} {mes}_{i} {ref}_{i}}{\sqrt{{\sum }_{i} {( {mes}_{i} )}^{2} \cdot {\sum }_{i} {( {ref}_{i} )}^{2}}}$$

The correlation coefficient is a normalized value and has a value range of [−1, 1]. The following values are obtained as the result for the selected candidates:
Line 1 northing value (=y): ρ=0.16
Line 1 casting value (=x): ρ=0.84
Line 2 northing value (=y): ρ=0.67
Line 2 casting value (=x): ρ=0.99

A comparison of the calculated correlation coefficient shows thus better agreement for Line 2 (correct result), with respect to the northing value as well as also to the casting value. However, this consideration must be carried out in connection with the mean deviation of the position, the trajectories to be compared from BTS sequence and HST sequence. The intervals of the individual mean values for the present example show the following values:
Line 1 northing value (=y): μ_{HST}−μ_{BTS}=125
Line 1 casting value (=x): μ_{HST}−μ_{BST}=120
Line 2 northing value (=y): μ_{HST}−μ_{BTS}=88
Line 2 easting value (=x): μ_{HST}−μ_{BTS}=328

In considering the position difference between BTS sequence and HST sequence, it is striking that with respect to the northing value Line 2 is better, while with respect to the easting value and total distance Line 1 yields the better results. However, caution must be exercised here because with respect to these parameters, apart from the absolute values, the dimensions in relation to the range of the BTS also pertain.

Since as the basis for the present calculation example a range for all BTSs of approximately 700 m was assumed, all four calculated differences of the mean values are within a meaningful range. Under these conditions, the result of the correlation coefficient is decisive.

If, on the other hand, the distance of the position between the trajectories markedly exceeds this value for the range, the similarity of shape loses significance.

### Processing the Results

From the four described methods the following parameters are determined:
Basic method: probability for the assignment of Start HST and destination HST through geometric calculation.
Improvement method: probability for the assignment of Start HST and destination HST by time comparison with the timetable.
1. Optimization method: correlation coefficient for the time comparison of the total travel chain.
2. Optimization method
i: correlation coefficient for the geometric comparison of the total travel chain with respect to the northing value.
ii: correlation coefficient for the geometric comparison of the total travel chain with respect to the casting value.
iii: position difference of the trajectories for the geometric comparison of the total travel chain with respect to the northing value.
iv: position difference of the trajectories for the geometric comparison of the total travel chain with respect to the casting value.

All of these parameters involve quasi indices for the examined candidates of the possible travel chain. Individual indices can be deficient, however, through the complete processing of indices chains, these errors can progressively be compensated.

The travel legs stated in connection with FIG. 2 are not described in connection with FIG. 6. However, they can readily also be applied to the method according to FIG. 6.

The method according to the invention can also be refined by considering further parameters. These parameters would in this case need to be provided, for example, by the mobile radio communication provider. Among these parameters are, for example, the distance between a BTS and a cell phone, which can be determined by measuring the loop running time. The geodesic course of the trajectories for individual lines or the distribution of the GSM field strength are also among these parameters. Information about time deviations of the lines from the timetable would also be helpful.

Up to now it had been assumed in the calculation examples that a base station has an omnidirectional antenna. However, it may also occur that at a BTS location several antennas are set up which are directed into different directions. Knowing the assumed range, as a probable location space for a logged-in cell phone, a circle sector is generated. Since the real location of the corresponding BTS antenna is at the margin of this location space, as the virtual location of the BTS antenna the center of gravity of the circle sector is calculated. In a statistical sense this virtual location comes closer to the possible location of the cell phone and thus increases the capability and performance of the method according to the invention.

When the route of a passenger is known from start to finish, i.e. also the lines he has utilized, the fare can be determined and be distributed over the individual lines. The fares of the various transportation organizations can, however, be highly different. Honeycomb systems thus exist, which are not concentric. However, there are also concentric annular zone fares with rings about a center, for example about a city center. There are furthermore combined systems with annular zones in the first stages and with outer zones which are divided according to segments. There are also systems with homogeneous fare zones, where the size of the fare zones is approximately equal. In other systems, where the fare zones are not homogeneous, the diameter of one zone or honeycomb can turn out very differently. There are, further, systems known in which each stop is assigned to only one zone; in other cases systematically boundary stops are available which—depending on the direction of approach—are assigned to different zones.

We claim:

1. Method for determining the path of a person equipped with a mobile phone device within a district provided with several base stations, characterized by the following steps:
a) the coordinates of path points or path legs are determined and stored;
b) the coordinates of the base stations are determined and stored;
c) with the mobile phone a signal is output to the base station with which the mobile phone is in radio contact;
d) it is determined with which base station the mobile radio device is in radio contact;
e) the coordinates of the base stations with which the mobile radio device is in radio contact are determined and compared with the coordinates of the path points or legs;
f) it is determined which coordinates of the path points or legs come closest to the coordinates of the base station with which the mobile radio device is in radio contact;
g) steps d) to f) are repeated at predetermined time intervals;
h) the itinerary is determined on the basis of the data obtained through steps c) to f).

2. Method as claimed in claim 1, characterized in that the coordinates of the path points or legs are the coordinates of stops.

3. Method as claimed in claim 1, characterized in that the coordinates of the path points or legs are arbitrary points of a transportation line network.

4. Method as claimed in claim 1, characterized in that the steps a) and b) are only performed once.

5. Method as claimed in claim 1, characterized in that the mobile phone outputs a signal to a base station at stops of public transportation means.

6. Method as claimed in claim 1, characterized in that the signal, output by the mobile phone to the base station, is output at a stop.

7. Method as claimed in claim 1, characterized in that the time of the output of the signal of the mobile phone is acquired.

8. Method as claimed in claim 7, characterized in that the time of the output of the signal of the mobile radio device is compared with the time specification of a timetable for public transportation means.

9. Method as claimed in claim 8, characterized in that the smallest time difference between the output of the signal of the mobile phone and a time specification of the timetable is determined.

10. Method as claimed in claim 1, characterized in that with the mobile phone a signal is output at a first point in time to the base station with which the mobile phone is currently in radio contact, and that at a second point in time a signal is output to that base station with which the mobile radio device is then in radio contact.

11. Method as claimed in claim 1, characterized in that there is a determination at certain time intervals of the base station into which the mobile radio device is logged.

12. Method as claimed in claim 11, characterized in that, additionally, the distance between a mobile radio device and a base station is determined.

13. Method as claimed in claim 12, characterized in that, additionally, the field strength is determined with which the mobile radio device transmits to a base station.

14. Method as claimed in claim 10, characterized in that the signal, output at the first point in time from the mobile phone to the base station, actuates an electronic ticket for public transportation means.

15. Method as claimed in claim 14, characterized in that the electronic ticket is stored in the mobile radio device.

16. Method as claimed in claim 10, characterized in that the first point in time marks the start of a ride of a mobile radio device using public transportation means and that the second point in time marks the end of this ride.

17. Method as claimed in claim 1, characterized in that after the output of the signal to the base station, the mobile radio device receives an SMS (Short Message Service) or MMS (Multimedia Messaging Service) with data content about the stop at which it is located.

18. Method as claimed in claim 17, characterized in that the SMS or MMS, in addition, also contains a specification of date and time of day.

19. Method as claimed in claim 17, characterized in that the signals received by the mobile radio device represent an electronic ticket.

20. Method as claimed in claim 1, characterized in that as the coordinates of the base station the virtual center of gravity of base station sectors is calculated.
